(19) United States
(12) Patent Application Publication
(10) Pub. No.: US 2026/0296785 A1
(43) Pub. Date: Oct. 1, 2026

(54) PARENT VEHICLE WITH OPTOELECTRONIC POSITIONING DEVICE FOR TRANSPORTING A LOAD IN AN AUTOMATED WAREHOUSE, LOADING METHOD AND UNLOADING METHOD AND WAREHOUSE

(71) Applicant: AUTOMHA S.P.A., Azzano San Paolo (Bergamo) (IT)

(72) Inventor: Walter DANNE, Azzano San Paolo (Bergamo) (IT)

(21) Appl. No.: 19/476,401

(22) PCT Filed: Apr. 19, 2024
(86) PCT No.: PCT/IB2024/053817

§ 371 Date: Oct. 17, 2025

(30) Foreign Application Priority Data
Apr. 20, 2023 (IT) 102023000007773

(51) Int. Cl. B65G 1/04

(52) U.S. Cl. CPC B65G 1/0492; B65G 2203/0233; B65G 2203/044

(57) ABSTRACT

A parent vehicle for transporting a satellite vehicle for automatically storing a load in a warehouse has a base frame onto which wheels allowing a translation of the parent vehicle along a transfer aisle of the warehouse are rotatably connected. A load transporting device of the parent vehicle is adapted to transport the load from an outer region with respect to a parent vehicle seat of the parent vehicle into the parent vehicle seat along a load transporting direction. An optoelectronic device is configured to generate a load detection signal, identifying a relative position of the load inside the parent vehicle seat. An electronic processing unit is configured to receive the load detection signal and process the load detection signal to calculate a relative distance of the load with respect to a physical reference of the parent vehicle.

### FIELD OF APPLICATION

The present invention falls within the field of the production of automated systems for the storage of items on pallets in an automated warehouse.

In particular, the present invention relates to a parent vehicle for transporting a satellite vehicle for automatically storing a load, in particular for storing and moving pallets containing items for automated warehouses. Furthermore, the present invention also relates to a method of loading the load, a method of unloading the load, and an automated warehouse which comprises a parent vehicle and is capable of performing the aforesaid loading and unloading methods.

### PRIOR ART

Automated warehouses structured to allow the automatic storage of pallets are known in the art.

From a design point of view, these warehouses normally employ load-bearing structures comprising a structure with shoulders and uprights that defines a plurality of storage aisles of variable dimensions according to the foreseen loads. The pallets are arranged and picked up along/from such aisles through automated devices, called satellites or shuttles. In practice, these devices deposit, automatically and in series, a plurality of pallets on support guides arranged along the storage aisle. In more detail, this deposit normally takes place starting from one end of an aisle or in any case from the first free position identified within the aisle itself.

In order to perform the operations for which it is intended, the satellite normally comprises a frame provided with a plurality of wheels so as to allow the satellite to be moved along the storage aisle.

These wheels are actuated by suitable handling means which generally consist of electric motors, which are operatively controlled by command and control means and which are powered by suitable power supply means, such as batteries.

The satellite further comprises two distinct sections suitable for providing a support surface for the pallet, as well as position detection means suitable for determining the position of the satellite in one or more points of the aisle, or means for detecting the position in a continuous manner, for example by means of laser position detection systems.

The satellite is powered by suitable on-board batteries or supercapacitors and their recharging may take place during the period in which the satellite is positioned in a further shuttle, also known as a transport parent vehicle. In particular, the parent vehicle is moved along transfer aisles, arranged transversely to the storage aisles, and houses or releases from time to time the satellites coming from the storage aisles for transporting the pallets to and from the storage aisles. An example of such type of warehouse, parent vehicle, and satellite vehicle is described in document WO2012127419A1.

One of the most important issues to be addressed in systems of this type is the need to ensure adequate accuracy in the positioning of pallets in storage aisles without losing storage speed and efficiency and therefore aiming to pack as many pallets inside the aisle as possible, avoiding dead spaces as much as possible. As will be understood by a person skilled in the art, obtaining these requirements proves to be rather challenging.

Obtaining the aforesaid requirements depends heavily on the chain of successive positions that follow from when the pallet is loaded onto the parent vehicle until the satellite vehicle, after correctly positioning itself in the parent vehicle underneath the pallet in order to pick it up, releases the pallet into the identified position in the aisle, generally as close as possible to another pallet.

To detect the positioning of the pallet in the parent vehicle, one or more presence photocells are provided in the devices of the prior art, positioned manually and specifically at a precise distance, equal to approximately size of the pallet used in the warehouse.

Consequently, in an inconvenient manner, a change in the size of the pallet used in the warehouse requires specific maintenance interventions on all the parent vehicles of the warehouse to vary the reading position of the photocells and their recalibration or requires a large number of photocells to be positioned in specific positions as a function of each size of the pallets to be used.

Furthermore, inconveniently, these types of readings by means of a simple photocell generate relatively high measurement errors in the position between the pallet and the parent vehicle and consequently between the pallet and the satellite vehicle. As a result, the satellite vehicle picks up the pallet in a position that is out of phase with respect to the optimal position, with a consequent increase in the dead spaces between the pallets once they are released from the satellite into the aisle.

### Solution of the Invention

The present invention therefore aims to remedy the aforementioned drawbacks relating to the prior art.

In particular, an object of the present invention is to provide a parent vehicle for moving a load in a warehouse which is capable of improving the relative positioning between the load and the parent vehicle and the consequent positioning in the storage aisles so as to improve storage efficiency without sacrificing the speed features of the systems of the prior art and while maintaining the construction costs and simplicity of such vehicles.

The aforesaid object is achieved by a parent vehicle, by a load loading method, by a load unloading method, and by an automated warehouse according to the appended independent claims. The dependent claims describe preferred embodiments.

### DESCRIPTION OF THE DRAWINGS

The features and advantages of the parent vehicle, the load loading method, the load unloading method, and the automated warehouse according to the present invention will be evident from the description below of some preferred embodiment examples, given as an indication and without limitation, with reference to the attached figures, wherein:

FIG. 1 is a perspective view of an automated warehouse for storing loads, for example pallets, according to an embodiment of the present invention;

FIG. 1a is a perspective view of a portion of an automated warehouse according to an embodiment of the present invention, wherein a parent vehicle according to an embodiment of the present invention houses a load and a satellite vehicle in its parent vehicle seat and is positioned on a transfer aisle;

FIG. 2 is a plan view from above of FIG. 1a;

FIG. 3 is the same perspective view of a portion of an automated warehouse of FIG. 2 wherein the load and the satellite vehicle are not on board the parent vehicle, i.e. are not housed in the parent vehicle seat, for example in a step of the unloading method of the load or in a step of the loading method;

FIG. 4 is an axonometric view of a parent vehicle according to an embodiment of the present invention;

FIG. 5 is a planar elevation view of the parent vehicle in FIG. 4;

FIG. 6 is a plan view from above of the parent vehicle in FIG. 4.

### DETAILED DESCRIPTION

While the present invention is described below with reference to preferred embodiments shown in the drawings, the present invention is not limited to the embodiments described below and shown in the drawings. On the contrary, the described and represented embodiments clarify some aspects of the present invention.

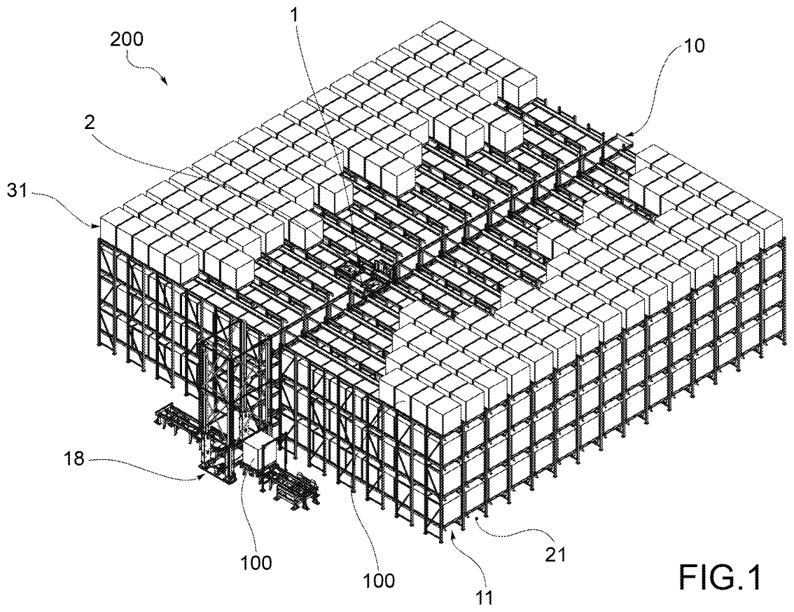

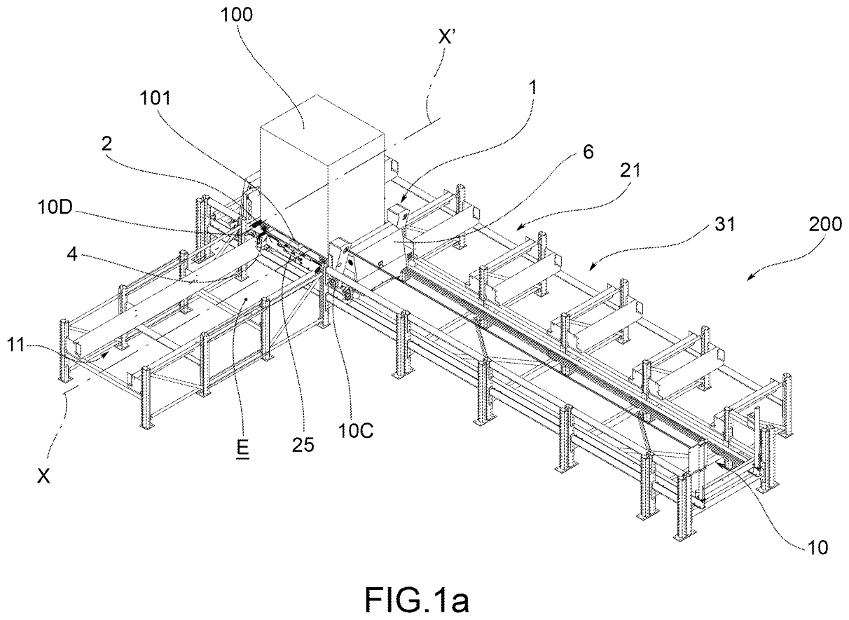

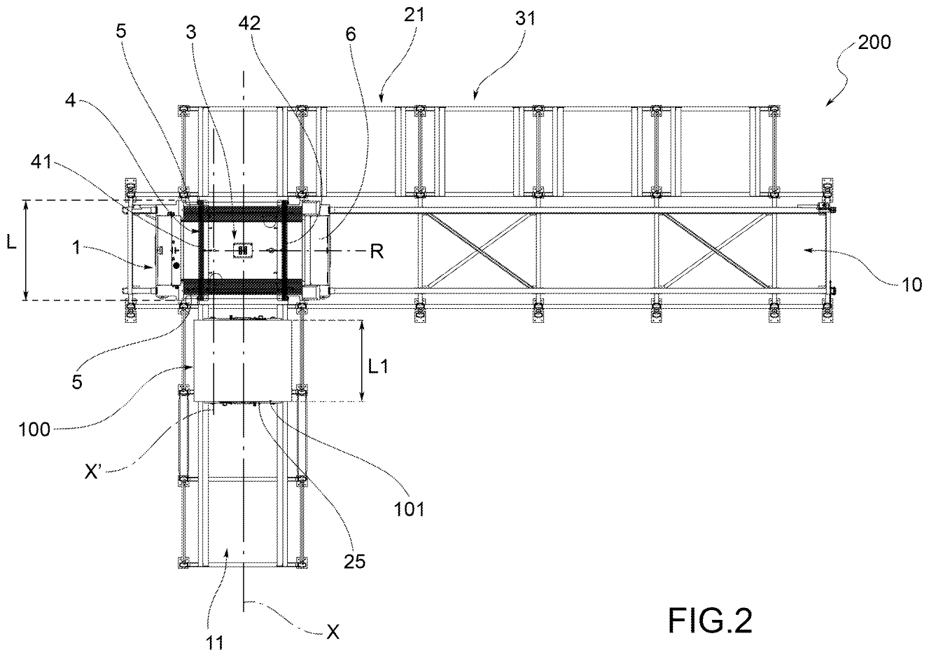

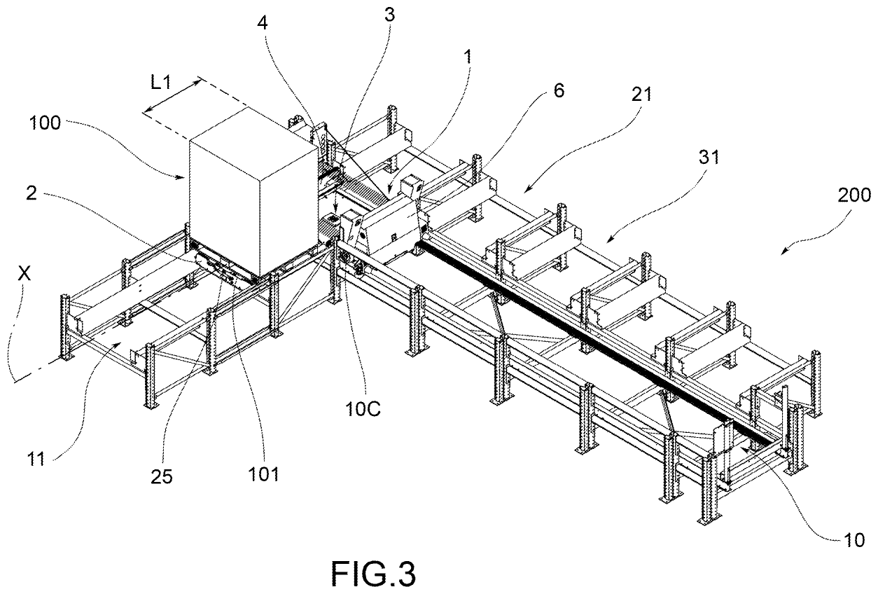

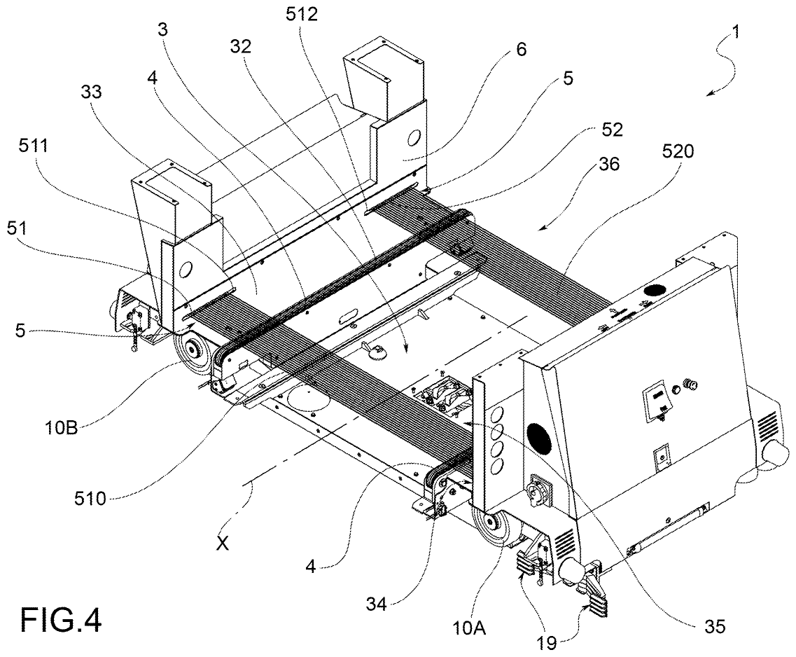

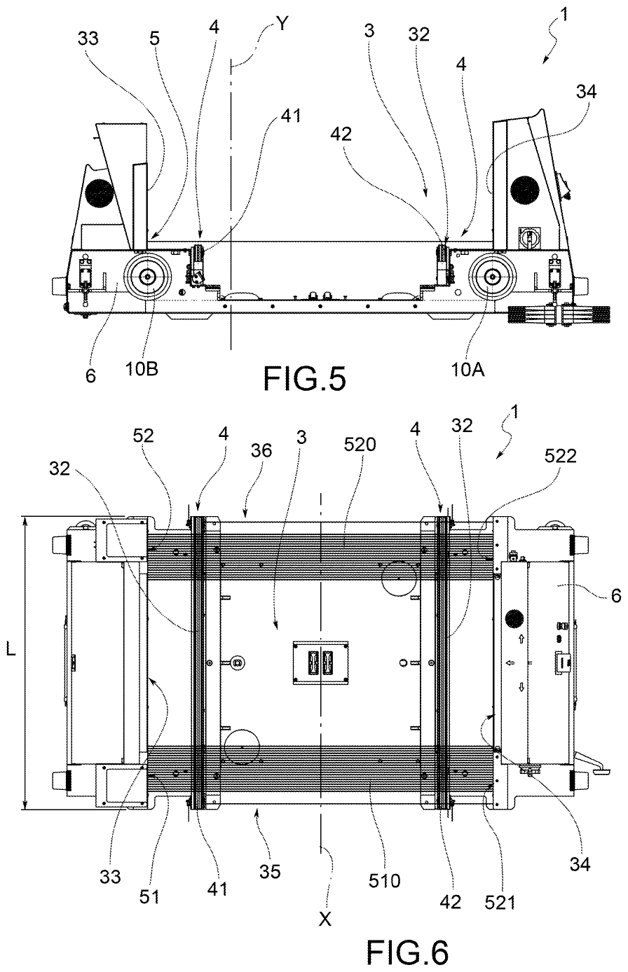

FIG. 1 schematically shows a warehouse 200 for storing loads 100, typically pallets, comprising a parent vehicle 1 according to a preferred embodiment of the invention.

The warehouse 200 shown in the figures by way of example has a simple layout and preferably comprises storage aisles 11, 21, 31 arranged laterally with respect to a central transfer aisle 10.

The warehouse 200 also preferably comprises a loading/unloading station 18 for the loads, or an area on which a load 100 which must be stored in a predetermined Compartment of the warehouse 200 is placed, or an area on which a load taken from a compartment of the warehouse 200 is placed.

The movement of a load 100 inside the warehouse 200 is advantageously carried out by the parent vehicle 1 according to the invention, together with a satellite vehicle 2, also shown.

The movement of the load 100 in the warehouse 200 consists, preferably, in moving said load from the loading/unloading station 18 towards and into the aisles 11, 21, 31.

The parent vehicle 1 according to the invention preferably allows the movement of loads of large dimensions and weights, such as pallets, but other types of items are not excluded.

The parent vehicle 1 according to the invention is therefore particularly suitable for moving pallets containing items for automatically storing the load 100 in a warehouse 200.

The parent vehicle 1 according to the invention is therefore suitable for transporting a satellite vehicle 2 for automatically storing a load 100, for example a pallet, in a warehouse 200 as previously described, for example a warehouse comprising storage aisles 11, 21, 31 for the load 100, mutually parallel and arranged on multiple levels, and at least one transfer aisle 10 arranged in an either incident or perpendicular direction with respect to the storage aisles 11, 21, 31.

The parent vehicle 1 comprises a base frame 6, for example having a shape that in vertical section is similar to a U or a C rotated by 90°, onto which wheels 10A, 10B, 10C, 10D suitable for allowing the translation of the parent vehicle 1 along the transfer aisle 10 of the warehouse 200 are rotatably connected.

The parent vehicle 1 also comprises a first actuator, for example an electrical motor and an electric power source, arranged inside said base frame 6 and operatively connected to one or more of said wheels 10A, 10B, 10C, 10D to achieve the translation of the parent vehicle 1.

According to an embodiment, the electrical power source comprises a cable or connector, connected to a skid device. This skid device 19 is suitable for making electrical contact with one or more electrified rails which make up the transfer aisle 10 or which are installed on the transfer aisle 10. For example, the skid device 19 is configured to slide in contact with one or more of said electrified rails.

The parent vehicle 1 also comprises a parent vehicle seat 3 suitable for transporting the load 100 and the satellite vehicle 2.

The satellite vehicle 2 comprises a vehicle frame on which wheels suitable for allowing the translation of the satellite vehicle along a storage aisle 11, 21, 31 of the warehouse 200 are rotatably connected. First handling means are operatively connected to one or more of said wheels to achieve the translation of the satellite vehicle 2. Furthermore, the satellite vehicle 2 comprises one or more operative portions defining a temporary support surface for the load 100 and second handling means arranged inside the frame and operatively connected to these operative portions, for example a pair of bars, to move them relative to the frame between a base position and a lifting position, spaced vertically with respect to the base position, so as to load the load by picking it up from the parent vehicle 1.

Preferably, the satellite vehicle 2 comprises main power supply means, for example a battery or a supercapacitor, mounted on said device so as to make the device autonomous and self-powered and rechargeable by said parent vehicle 1 when arranged on board the parent vehicle 1.

According to an embodiment, a central control unit integrally associated with the frame of the satellite vehicle 2 controls all moving parts of the satellite vehicle and the communication with the sensors.

As regards the parent vehicle 1, according to an embodiment, the parent vehicle seat 3 is obtained in the base frame 6 and is preferably contained in the side walls of the U or C shape previously described and as seen in the figures.

The parent vehicle 1 further comprises a load transporting device 4, e.g., one or more load conveyor chains 41, 42, suitable for transporting the load 100 from an outer region E, which is external to the parent vehicle seat 3, towards the inside of the parent vehicle seat 3 along a load transporting direction X, for example from a conveyor or storage aisle 11 to the parent vehicle seat 3. In this way, for example, by means of the load transporting device 4, the load 100 is carried on board the parent vehicle 1 without the need for it to be picked up and moved by the satellite vehicle 2.

The parent vehicle 1 also comprises a second actuator, for example an electric motor and a possible transmission system, operatively connected to the load transporting device 4 for handling the load 100 along the load transporting direction X.

According to the invention, the parent vehicle comprises at least one optoelectronic device 5, for example a laser beam light barrier 51 (for example laser beams produced by a certain light frequency, e.g., red or infrared or other frequencies) or otherwise a non-contact and non-visible electromagnetic radiation optoelectronic device, configured to generate a load detection signal, identifying the relative position of the load 100 inside the parent vehicle seat 3.

The parent vehicle 1 also comprises an electronic processing unit, preferably positioned on board the base frame 6, configured to receive the load detection signal and process said signal to calculate a relative distance of the load 100 with respect to a physical reference of the parent vehicle 1, for example with respect to a central axis R of the parent vehicle seat 3 positioned on the centerline of the extension L of the parent vehicle seat 3 in the load transporting direction X.

Preferably, the electronic processing unit is also configured to communicate with a warehouse management unit on which a warehouse software program manages the operation of the warehouse 200 and in particular the movements of the parent vehicle 2 within the warehouse 200. The communication between the electronic processing unit and the warehouse management unit is preferably wireless communication.

According to an embodiment, the optoelectronic device 5 comprises a first laser beam light barrier 51, comprising a plurality of laser beams mutually spaced apart along the load transporting direction X and arranged transversely with respect to the load transporting direction X in the parent vehicle seat 3, said first laser beam light barrier 51 being configured to generate the load detection signal as a function of the number of laser beams interrupted by the load 100 when it is inserted into the parent vehicle seat 3. This allows for a measurement of the relative position of the load 100, for example the base of the pallet, within the parent vehicle seat 3 to be obtained precisely and accurately and independently of the specific size of the load.

According to an embodiment, the first laser beam light barrier 51 extends along the entire length of the parent vehicle seat 3 in the load transporting direction X.

According to an alternative embodiment, shown for example in the accompanying figures, the optoelectronic device 5 comprises at least a first laser beam light barrier 51 and a second laser beam light barrier 52 mutually spaced apart along the load transporting direction X. Each of said first and second laser beam light barriers 51, 52 comprises a respective plurality of laser beams 510, 520 mutually spaced apart along the load transporting direction X and arranged transversely with respect to the load transporting direction X in the parent vehicle seat 3. Furthermore, each of said first 51 and second laser beam light barriers 52 is configured to generate the load detection signal as a function of the number of laser beams interrupted by the load 100 in both the first 51 and in the second laser beam light barrier 52. This makes it possible to detect the beginning and the end of the load 100 in an optimized, redundant, and resource-saving manner with respect to the variant with a single laser beam light barrier.

According to an embodiment, the electronic processing unit is further configured to process the load detection signal to calculate a load length L1 relative to the load extension length along a loading direction X′ parallel to the load transporting direction X. In this way, with the extension length of the load known, it is possible to calculate the distance to be traveled by the transporting device 4 to be centered with respect to the parent vehicle seat 3 or to be correctly moved when it is to be picked up from the satellite vehicle 2.

Preferably, the electronic processing unit is configured to compare said load length L1 with a predetermined load length value previously stored in an electronic storage unit. In this way it is possible to determine the type of load, for example a pallet, loaded.

According to an embodiment, the parent vehicle seat 3 comprises a support surface 32, suitable for receiving the load 100 resting thereon, a first vertical wall 33 extending along a perpendicular direction Y to the support surface 32, and a second vertical wall 34, parallel to the first vertical wall 33 and arranged to be spaced apart from and opposite to said first vertical wall 33.

According to an embodiment, the parent vehicle seat 3 defined by the aforesaid support surface 32, first vertical wall 33, and second vertical wall 34 is advantageously open on both opposite open sides 35, 36 that flank said first vertical wall 33 and second vertical wall 34, so as to allow the movement of the load 100 along the load transporting direction X from both opposite open sides 35, 36, both exiting and entering the parent vehicle seat 3. Furthermore, the opening of both opposite open sides 35, 36 of the parent vehicle seat 3 further allows for the detection of the load to be optimized in the variant with a first laser beam light barrier 51 and a second laser beam light barrier 52 because the presence of the load 100 and its position may be detected both when it is loaded/unloaded on one side and on the opposite side.

Preferably, a laser beam emitting device 511, 512 of each of the first and second laser beam light barriers 51, 52 is fixed on the first wall 33 and a laser beam receiving device 521, 522 of each of the first and second laser beam light barriers 51, 52 is fixed on the second vertical wall 34. It is clear that, in one embodiment, the laser beam receiving device 521, 522 may be a laser beam transporting direction device, thus replacing the receiving device. It is clear to a person skilled in the art that, in the latter case, the laser beam emitting device may also act as a detector for the presence or absence of the laser beam reflected by the reflecting device.

Preferably, each laser beam emitting device 511, 512 of each of the first and second laser beam light barriers is fixed close to the support surface 32 and spaced apart from the support surface 32 such that the laser beams of each emitting device are less than fifteen centimeters away from the support surface 32. This makes it possible to correctly measure the size of the base of the pallet and avoid measuring the object or objects arranged on the base of the pallet.

As mentioned above, a method for loading a load 100 onto a parent vehicle 1 according to any of the embodiments described above is also a subject matter, per se, of the present invention. The method comprises the following operative steps:
a) in the electronic processing unit, calculating or setting a target distance to be reached by the load 100 in the parent vehicle seat 3 with respect to a physical reference R, for example a distance to be traveled by the load with respect to a centerline axis of the parent vehicle seat 3 to be positioned in a centered manner in the seat;
b) while keeping the parent vehicle 1 stationary, loading the load 100 into the parent vehicle seat 3 by means of the load transporting device 4, for example by moving the load onto the conveyor chains 41, 42;
c) detecting the position of the load 100 with respect to the physical reference R of the parent vehicle and calculating a relative distance of the load 100 with respect to the physical reference R of the parent vehicle, for example with respect to a central axis R of the parent vehicle seat positioned on the centerline of the extension L of the parent vehicle seat in the load transporting direction X;
d) handling the load 100 in the parent vehicle seat 3 in the load transporting direction X, by repeating step c) in order to calculate the error between the relative distance and the target distance, until the target distance with respect to the physical reference R is reached;
e) with the load 100 being stationary in the position reached in step d) as a function of the target distance reached, moving the parent vehicle 1 along the transfer aisle 10 of the warehouse.

Preferably, in step d), the load 100, once it has reached the target distance with respect to the physical reference R, is positioned in a centered manner with respect to the extension of the parent vehicle seat 3 along the load transporting direction X. In this way, the method allows the load to be correctly centered on the parent vehicle 1 and transported without unbalanced load conditions on the vehicle.

The present invention likewise relates to a method for unloading a load 100 from a parent vehicle 1 according to any of the embodiments described above. The method comprises the following operative steps:
a′ ) moving a satellite vehicle 2 in the parent vehicle seat 3 underneath the load 100;
b′) in the electronic processing unit, selecting a target unloading distance to be reached by the load 100 in the parent vehicle seat 3 with respect to a physical reference R;
c′ ) handling the load 100 by means of the load transporting device 4 to reach the target unloading distance so that the distance between a loading edge 101 of the load 100 facing a storage aisle 11 and an extreme edge 25 of the satellite vehicle 2 facing the same storage aisle 11 is less than fifteen centimeters along the load transporting direction X, preferably less than five centimeters;
d′) picking the load 100 by means of the satellite vehicle 2 and moving the load assembly 100 and satellite vehicle 2 out of the parent vehicle seat 3 along the load transporting direction X in the storage aisle 11.

As will become clear to a person skilled in the art, step c′ ) described above allows the top load 100 to be loaded onto the satellite vehicle 2, i.e., with the extreme edge 25 of the satellite vehicle almost aligned with the loading edge 101 of the load 100, so that when the satellite vehicle 2 releases the load 100 into the storage aisle 11 it will be possible to position it very close to another load (for example a pallet) already present in the aisle, and said load 100 just released will be very close to the other load, thus reducing the minimum dead space between the two adjacent loads.

As already mentioned, the subject matter of the present invention is also an automated warehouse 200 for automatically storing a plurality of loads, such as pallets, for example, comprising storage aisles 11, 21, 31 for the load 100, mutually parallel and arranged on multiple levels, and at least one transfer aisle 10 arranged in an either incident or perpendicular direction with respect to the storage aisles 11, 21, 31. This automated warehouse also comprises at least one parent vehicle 1 according to any of the embodiments described above and a satellite vehicle 2.

A person skilled in the art will understand that the additional technical features of the parent or satellite vehicle not specifically described in this discussion are known to a person skilled in the art, both by the already known commercial vehicles in circulation and at least by the entire description of document WO2012127419A1, the content of which is intended to be included herein.

Innovatively, by virtue of the presence of the optoelectronic device, the present invention allows a load to be transported within an automated warehouse, improving the positioning precision, and reducing the mounting and calibration time of each vehicle as a function of the specific load operated. In other words, the present invention makes it possible to increase the versatility in the management of pallets of different sizes, without having to excessively increase the complexity of the parent vehicle and without having to insert specific photocells into fixed positions from time to time, thus reducing the relative costs.

Furthermore, reading the length of the load base (i.e. of the bed of the pallet) allows for verifying the correspondence of this length with the length stored and expected by the parent vehicle and provided by the warehouse management unit, increasing the redundancy in the control.

Furthermore, the presence of laser beam light barriers ensures adequate measurement and positioning precision, without contact, and also allows for substantial retrofitting even of already existing parent vehicles equipped with photocells in the same positions.

Additionally, an advantage of having both a first and a second laser light barrier is redundancy and precision in load detection. This arrangement makes it possible to accurately determine both the presence and the exact position of the load inside the parent vehicle. Using two barriers, the system may verify the initial reading, reducing the probability of errors in load positioning, improving the reliability and precision of vehicle operations.

Furthermore, an advantage of configuring the electronic processing unit to calculate the length of the load is the ability to automatically adapt to the different dimensions of the load. This feature allows the vehicle to adapt the load moving strategies according to the specific dimensions of the load, optimizing the use of space and ensuring more stable and secure transport of the load inside the parent vehicle. This also contributes to a leaner operation by dynamically modifying the operating conditions of the vehicle in the warehouse.

Moreover, an advantage of having the electronic processing unit which compares the measured load length with a pre-stored length value is greater efficiency in verifying and moving the load. This feature enables the automated confirmation that the correct load is processed, which is critical for inventory control and error reduction in the loading and unloading processes. It also helps in the immediate identification and resolution of discrepancies, improving the operative precision and reliability of the warehouse management system.

It is clear that a person skilled in the art may make changes to the invention in order to meet contingent needs, said changes all falling within the scope of protection as defined in the following claims.

1. A parent vehicle for transporting a satellite vehicle for automatically storing a load, in a warehouse comprising storage aisles for the load, mutually parallel and arranged on multiple levels, and at least one transfer aisle arranged in an either incident or perpendicular direction with respect to the storage aisles, said parent vehicle comprising:
a base frame onto which wheels suitable for allowing a translation of the parent vehicle along the transfer aisle of the warehouse are rotatably connected;
a first actuator, arranged inside the base frame and operatively connected to one or more of the wheels to achieve the translation of the parent vehicle,
a parent vehicle seat suitable for transporting the load and satellite vehicle;
a load transporting device, optionally the load transporting device being one or more conveyor chains, suitable for transporting the load from an outer region with respect to the parent vehicle seat into the parent vehicle seat along a load transporting direction;
a second actuator operatively connected to the load transporting device for handling the load along the load transporting direction;
at least one optoelectronic device, configured to generate a load detection signal, identifying the relative position of the load inside the parent vehicle seat; and
an electronic processing unit, configured to receive the load detection signal and process the load detection signal to calculate a relative distance of the load with respect to a physical reference of the parent vehicle.

2. The parent vehicle according to claim 1, wherein the at least one optoelectronic device comprises a first laser beam light barrier comprising a plurality of laser beams mutually spaced apart along the load transporting direction and arranged transversely with respect to the load transporting direction in the parent vehicle seat, the first laser beam light barrier being configured to generate the load detection signal as a function of the number of laser beams interrupted by the load when the load is inserted into the parent vehicle seat.

3. The parent vehicle of claim 1, wherein the a least one optoelectronic device comprises at least a first laser beam light barrier and a second laser beam light barrier mutually spaced apart along the load transporting direction, each of the first and second laser beam light barriers comprising a respective plurality of laser beams mutually spaced apart along the load transporting direction and arranged transversely with respect to the load transporting direction in the parent vehicle seat, each of the first and second laser beam light barriers being configured to generate the load detection signal as a function of a the number of laser beams interrupted by the load in both the first and second laser beam light barriers.

4. The parent vehicle of claim 1, wherein the electronic processing unit is further configured to process the load detection signal to calculate a load length relative to a load extension length along a loading direction parallel to the load transporting direction.

5. The parent vehicle of claim 4, wherein the electronic processing unit is configured to compare the load length with a predetermined load length value previously stored in an electronic storage unit.

6. The parent vehicle of claim 3, wherein the parent vehicle seat comprises a support surface suitable for receiving the load resting thereon, a first vertical wall extending along a perpendicular direction to the support surface, and a second vertical wall parallel to the first vertical wall and arranged to be spaced apart from and opposite to the first vertical wall, and wherein a laser beam emitting device of each first and second laser beam light barriers is fixed to the first vertical wall and a laser beam receiving or reflecting device of each first and second laser beam light barrier is fixed to the second vertical wall.

7. The parent vehicle to claim 6, wherein each laser beam emitting device of each first and second laser beam light barrier is fixed close to the support surface and spaced apart from the support surface such that the laser beams of each laser beam emitting device are less than fifteen centimeters away from the support surface.

8. A method of loading a load onto a parent vehicle for transporting a satellite vehicle for automatically strong the load inside a warehouse comprising storage aisles for the load, mutually parallel and arranged on multiple levels, and at least one transfer aisle arranged in an either incident or perpendicular direction with respect to the storage aisles, the parent vehicle comprising:
a base frame onto which wheels suitable for allowing a translation of the present vehicle along the at least one transfer aisle of the warehouse are rotatably connected;
a first actuator arranged inside the bae frame and operatively connected to one or more of the wheels to achieve the translation of the parent vehicle,
a parent vehicle seat suitable for transporting the load and the satellite vehicle;
a load transporting device, optionally the load transporting device being one or more conveyor chains, suitable for transporting the load from an outer region with respect to the parent vehicle seat into the parent vehicle seat along a load transporting direction;
a second actuator operatively connected to the load transporting device for handling the load along the load transporting direction;
at lease one optoelectronic device configured to generate a load detection signal, identifying a relative position of the load inside the parent vehicle seat; and
an electronic processing unit, configured to receive the load detection signal and process the load detection signal to calculate a relative distance of the load with respect to a physical reference of the parent vehicle,
the method comprising the following operating steps:
a) in the electronic processing unit, selecting a target distance for the load to be reached in the parent vehicle seat with respect to a physical reference;
b) while keeping the parent vehicle stationary, loading the load into the parent vehicle seat by the load transporting device;
c) detecting the position of the load with respect to the physical reference of the parent vehicle and calculating the relative distance of the load with respect to the physical reference of the parent vehicle;
d) handling the load in the parent vehicle seat in the load transporting direction until the target distance with respect to the physical reference (R) is reached; and
e) with the load being stationary in the position reached in step d) as a function of the target distance reached, moving the parent vehicle along the at least one transfer aisle of the warehouse. for transporting a satellite vehicle for automatically storing the load inside a warehouse comprising storage aisles for the load, mutually parallel and arranged on multiple levels, and at least one transfer aisle arranged in an either incident or perpendicular direction with respect to the storage aisles, the parent vehicle comprising:
a base frame onto which wheels suitable for allowing a translation of the parent vehicle along the at least one transfer aisle of the warehouse are rotatably connected;
a first actuator arranged inside the base frame and operatively connected to one or more of the wheels to achieve the translation of the parent vehicle;
a parent vehicle seat suitable for transporting the load and the satellite vehicle;
a load transporting device, optionally the load transporting device being one or more conveyor chains, suitable for transporting the load from an outer region with respect to the parent vehicle seat into the parent vehicle seat along a load transporting direction;
a second actuator operatively connected to the load transporting device for handling the load along the load transporting direction;
at least one optoelectronic device configured to generate a load detection signal, identifying a relative position of the load inside the parent vehicle seat; and
an electronic processing unit, configured to receive the load detection signal and process the load detection signal to calculate a relative distance of the load with respect to a physical reference of the parent vehicle;
the method comprising the following operating steps:
a′) moving the satellite vehicle in the parent vehicle seat underneath the load;
b′) in the electronic processing unit, selecting a target unloading distance for the load to be reached in the parent vehicle seat with respect to the physical reference;
c′) handling the load by the load transporting device to reach the target unloading distance such that a distance between a loading edge of the load facing a storage aisle and an extreme edge of the satellite vehicle facing the the same storage aisle is less than fifteen centimeters along the load transporting direction; and
d′) picking the load by the satellite vehicle and moving the load and satellite vehicle out of the parent vehicle seat along the load transporting direction in the storage aisle.

11. An automated warehouse for automatically storing a plurality of loads, optionally the plurality of loads being pallets, comprising storage aisles for the load, mutually parallel and arranged on multiple levels, and at least one transfer aisle arranged in an either incident or perpendicular direction with respect to the storage aisles, the automated warehouse comprising at least one parent vehicle according to claim 1 and a satellite vehicle.

12. The parent vehicle of claim 1, wherein the load is a pallet.

13. The parent vehicle of claim 1, wherein the load transporting device is suitable for transporting the load from a conveyor or one of the storage aisles to the parent vehicle seat.

14. The parent vehicle of claim 1, wherein the electronic processing unit calculates the relative distance of the load with respect to a central axis of the parent vehicle seat positioned on a centerline of an extension of the parent vehicle seat in the load transporting direction.

15. The method of claim 8, wherein the load is a pallet.

16. The method of claim 8, wherein the load transporting device is suitable for transporting the load from a conveyor or one of the storage aisles to the parent vehicle seat.

17. The method of claim 8, wherein the relative distance of the load is calculated with respect to a central axis of the parent vehicle seat positioned on a centerline of an extension of the parent vehicle seat in the load transporting direction.

18. The method of claim 10, wherein the load is a pallet.

19. The method of claim 10, wherein the electronic processing unit calculates the relative distance of the load with respect to a central axis of the parent vehicle seat positioned on a centerline of an extension of the parent vehicle seat in the load transporting direction.

20. The method of claim 10, wherein the distance between the loading edge of the load facing the storage aisle and the extreme edge of the satellite vehicle facing the same storage aisle is less than five centimeters along the load transporting direction.
